(19) United States
(12) Patent Application Publication
(10) Pub. No.: US 2014/0101739 A1
(43) Pub. Date: Apr. 10, 2014

(54) SEMANTIC CHALLENGE FOR AUDIO HUMAN INTERACTIVE PROOF

(71) Applicant: MICROSOFT CORPORATION, Redmond, WA (US)

(72) Inventors: Weisheng Li, Bothell, WA (US); Prabu Raju, Issaquah, WA (US)

(73) Assignee: Microsoft Corporation, Redmond, WA (US)

(21) Appl. No.: 13/647,390

(22) Filed: Oct. 9, 2012

(51) Int. Cl. H04L 9/32

(52) U.S. Cl. 726/7

(57) ABSTRACT

In one embodiment, a human interactive proof portal 140 may control access to an online data service 122. A communication interface 260 establishing a human interactive proof session 600 with a user device 110 accessing an online data service 122. The communication interface 260 may iteratively send an audio proof challenge set having multiple audio proof challenges each asking a semantic query to the user device 110 for presentation to a user. A processor 220 may provide access to the online data service 122 based in part on at least one proof response having a semantic reply indicating a human user.

### BACKGROUND

A data service may provide services for free on the internet. A malicious entity may take advantage of these services using software applications that pretend to be human users. The software applications may overtax the server for the data service, hijack the data service for nefarious use, or interrupt normal use of the data service. For example, the software applications may set up fake free e-mail accounts to send out spam, hoard sale products for nefarious purposes, or may strip mine a public database.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to controlling access to an online data service. A communication interface establishing a human interactive proof session with a user device accessing an online data service. The communication interface may iteratively send an audio proof challenge set having multiple audio proof challenges each asking a semantic query to the user device for presentation to a user. A processor may provide access to the online data service based in part on at least one proof response having a semantic reply indicating a human user.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a data network.

FIG. 2 illustrates, in a block diagram, one embodiment of a computing device.

FIG. 3 illustrates, in a block diagram, one embodiment of the automatic generation of an audio proof challenge.

FIG. 4 illustrates, in a block diagram, one embodiment of a location record.

FIG. 5 illustrates, in a block diagram, one embodiment of a user record.

FIG. 6 illustrates, in a flow diagram, one embodiment of a human interactive proof session.

FIG. 7 illustrates, in a flowchart, one embodiment of a method for controlling access to an online data service.

FIG. 8 illustrates, in a flowchart, one embodiment of a method for executing a human interactive proof session.

FIG. 9 illustrates, in a flowchart, one embodiment of a method for adjusting a response threshold based on user performance.

FIG. 10 illustrates, in a flowchart, one embodiment of a method for generating an audio proof challenge set.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a tangible machine-readable storage medium having a set of instructions detailing a method stored thereon for at least one processor, or a human interactive proof portal.

As opposed to a standard human interactive proof, in which a user reads or listens to a word then types that word for transmission to a human interactive proof portal, a user may listen to an audio proof challenge with a semantic query and infer or interpret the semantic queries to come up with the answer. A semantic query is a question designed to provoke a human cognitive process to determine the answer. The human interactive proof portal may engage the user in an interactive session with multiple audio challenge and responses with a varying pattern.

As the user interacts with each audio proof challenge, the user may interpret the question and content by providing a proof response. The human interactive proof portal may calculate the statistics of the correctness of the proof response with each interaction. The human interactive proof portal may leverage the statistics of the response time on each interaction. When the user response score is at or above the response threshold, the human interactive proof portal may determine the human interactive proof session successful and the user is allowed to proceed with the intended task. When the user response score is below a response threshold and the number of attempts reaches the challenge set size, the human interactive proof portal may determine the human interactive proof session unsuccessful.

The human interactive proof portal may provide a semantic query as an audio data file in an interactive pattern. The user may understand and interpret the query to come up with a response on each interaction. For each interactive session, the human interactive proof portal may provide a collection of semantic queries. Each semantic query may have a template with placeholders. The placeholders may be randomly filled from a vocabulary set. When the semantic query is constructed, the corresponding correct response may be generated at runtime. The semantic query may be targeted to receive a response from a limited response pool. With this pattern, the human interactive proof portal may create a corpus of random semantic queries on each user interaction session.

The human interactive proof portal may frame each semantic query to allow a genuine user to answer the semantic query quickly. In a typical interactive session, the user may experience a series of semantic questions, answering one by one till the human interactive proof portal reaches the verdict, either reaching the response threshold or the challenge set size.

The human interactive proof portal may track the minimum number of audio proof challenges in a human interactive proof session, the maximum number of audio proof challenges in a human interactive proof session, a lower response threshold below which the human interactive proof session fails, and an upper response threshold below which the human interactive proof session succeeds.

The human interactive proof portal may serve one semantic query as audio content in each interaction. When the user solves the challenge and enters the answer, the user may receive the next semantic query as an audio proof challenge. On receiving each answer, the human interactive proof portal may compute the user response score leveraging the statistics of time taken to enter the answer. Additionally, the human interactive proof portal may factor in the geo-location of the user, the reputation of the internet protocol address, user success rate on previous responses, and other user data to determine if the user is a benign human or a malicious actor. If the number of interactions is greater than or equal to the minimum number of interactions and the user response score is at or above the upper response threshold, the human interactive proof portal may judge the human interactive proof session successful and allow the user to access to the online data service. If the number of interactions is greater than or equal to the minimum number of interactions and the user response score is below the lower response threshold, the human interactive proof portal may judge the human interactive proof session unsuccessful and deny the user access to the online data service. If the number of interactions is greater than or equal to the minimum number of interactions and the user response score is between the upper and the lower response threshold, the human interactive proof portal may provide further audio proof challenges. If the number of interactions is equal to the maximum number of interactions and the user response score is below the upper response threshold, the human interactive proof portal may judge the human interactive proof session unsuccessful and deny the user access to the online data service.

Thus, in one embodiment, a human interactive proof portal may control access to an online data service. A communication interface establishing a human interactive proof session with a user device accessing an online data service. The communication interface may iteratively send an audio proof challenge set having multiple audio proof challenges each asking a semantic query to the user device for presentation to a user. A processor may provide access to the online data service based in part on at least one proof response having a semantic reply indicating a human user.

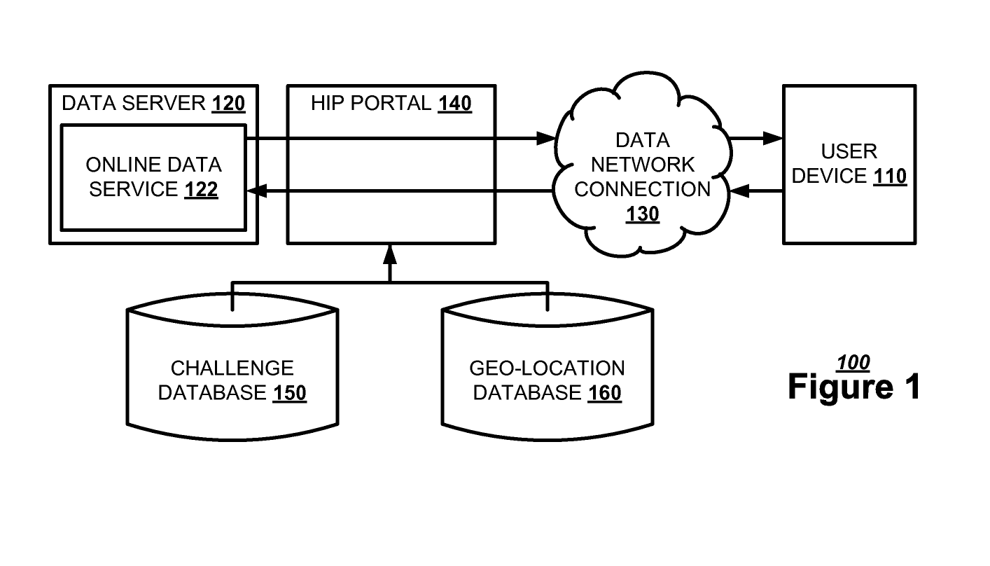

FIG. 1 illustrates, in a block diagram, one embodiment of a data network 100. A user device 110 may connect to a data server 120 via a data network connection 130, such as the internet. The user device 110 may access an online data service 122 executed by the data server 120. The online data service 122 may protect access to the service using a human interactive proof portal 140. The human interactive proof portal 140 may be executed by the data server 120 or by a separate server. The human interactive proof portal 140 may use an audio proof challenge database 150 to provide an audio proof challenge set to send to the user device 110 for presentation to a user. Each audio proof challenge in the audio proof challenge set may ask a semantic query of the user. A semantic query is a query that asks a question of the user, causing the user to analyze the semantic query to determine a semantic response. The audio proof challenge database 150 may store pre-defined audio proof challenges. Alternately, the audio proof challenge database 150 may store a semantic query template and a vocabulary set so that the human interactive proof portal 140 may automatically generate the audio proof challenge.

The human interactive proof portal 140 may consider other factors in determining a response threshold, such as the reputation of the internet protocol address, the geo-location of the user, statistics about the interaction time during a human interactive proof session, response success rate, or other factors. The human interactive proof portal 140 may use a geo-location database 160 to identify a geo-location for the user device 110 by using the internet protocol address originating the access request to identify the actual geo-location.

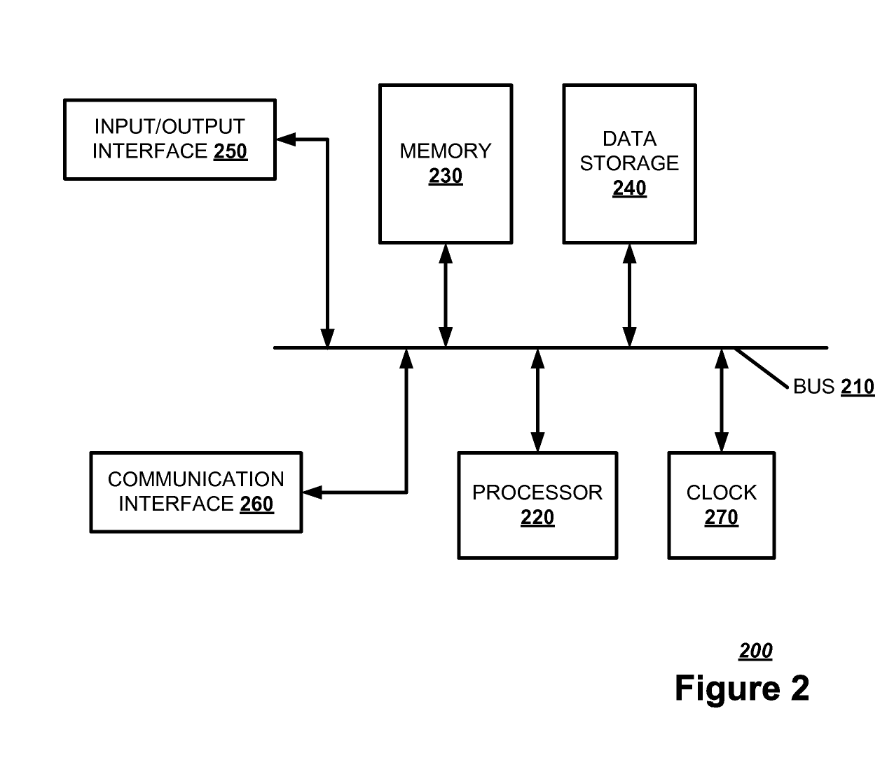

FIG. 2 illustrates a block diagram of an exemplary computing device 200 which may act as a user device 110, a data server 120, or a human interactive portal 140. The computing device 200 may combine one or more of hardware, software, firmware, and system-on-a-chip technology to implement a user device 110, a data server 120, or a human interactive proof portal 140. The computing device 200 may include a bus 210, a processor 220, a memory 230, a data storage 240, an input/output device interface 250, a communication interface 260, and a clock 270. The bus 210, or other component interconnection, may permit communication among the components of the computing device 200.

The processor 220 may include at least one conventional processor or microprocessor that interprets and executes a set of instructions. The memory 230 may be a random access memory (RAM) or another type of dynamic data storage that stores information and instructions for execution by the processor 220. The memory 230 may also store temporary variables or other intermediate information used during execution of instructions by the processor 220. The data storage 240 may include a conventional ROM device or another type of static data storage that stores static information and instructions for the processor 220. The data storage 240 may include any type of tangible machine-readable medium, such as, for example, magnetic or optical recording media, a digital video disk, or a corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 240 may store a set of instructions detailing a method that when executed by one or more processors cause the one or more processors to perform the method. The data storage 240 may also be a database or a database interface with the audio proof challenge database 150 or the geo-location traffic database 160.

The input/output device interface 250 may include one or more conventional mechanisms that permit a user to input information to the computing device 200, such as a keyboard, a mouse, a voice recognition device, a microphone, a headset, a gesture capture device, a touch screen, etc. The input/output device interface 250 may include one or more conventional mechanisms that output information to the user, including a display, a printer, one or more speakers, a headset, or a medium, such as a memory, or a magnetic or optical disk and a corresponding disk drive. The communication interface 260 may include any transceiver-like mechanism that enables computing device 200 to communicate with other devices or networks. The communication interface 260 may include a network interface or a transceiver interface. The communication interface 260 may be a wireless, wired, or optical interface. The clock 270 may provide timing information for various functions performed by a user device 110 or a human interactive portal 140. For example, the clock 270 may record a challenge response time for each audio proof challenge or an overall response time for a human interactive proof session.

The computing device 200 may perform such functions in response to a processor 220 executing sequences of instructions contained in a computer-readable medium, such as, for example, the memory 230, a magnetic disk, or an optical disk. Such instructions may be read into the memory 230 from another computer-readable medium, such as the data storage 240, or from a separate device via the communication interface 260.

The human interactive proof portal 140 may establish a human interactive proof session with the user device 110 to determine whether to grant access to the online data service 122. The human interactive proof portal 140 may send an audio proof challenge set having multiple audio proof challenges for the user device 110 to solve. The audio proof challenge database 150 may store a pre-defined set of audio proof challenges or may store a set of semantic query templates and a vocabulary set to facilitate the human interactive proof portal 140 with the automatic generation of the audio proof challenges.

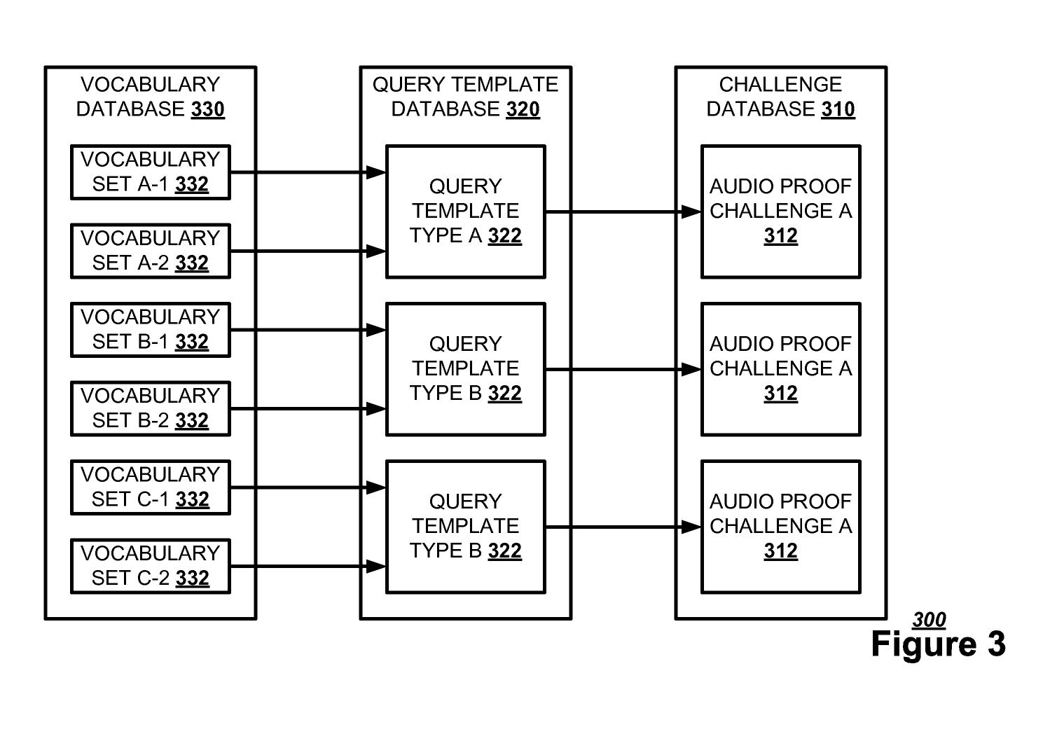

FIG. 3 illustrates, in a block diagram, one embodiment of the automatic generation 300 of an audio proof challenge. An audio proof challenge database 150 may store a challenge database 310 containing one or more pre-defined audio proof challenges 312 for use by the human interactive proof portal 140. Alternately or additionally, an audio proof challenge database 150 may store a semantic query template database 320 and a vocabulary set database 330 for use by the human interactive proof in generating an audio proof challenge 312. The semantic query template database 320 may store a variety of semantic query templates 322 to allow a human interactive proof portal to challenge a user with multiple different types of semantic queries with a variety of template complexities. A semantic query template 322 is a grammatical structure for a semantic query in a proof challenge. For example, the semantic query template 322 may say “Write down how many <objects> in total? <nb_{—}1> <o_{—}1> . . . <nb_n> <o_n>”.

Each semantic query template 322 may have one or more associate vocabulary sets 332 in the vocabulary set database 330. A vocabulary set 332 is a set of one or more words that may be input into the semantic query template. For example, the vocabulary set may be “trees books tables cats dogs”. The human interactive proof portal 140 may input the vocabulary set 332 into the semantic query template 322 to create an audio proof challenge 312. Based on the previous examples, the audio proof challenge 312 may be “Write down how many books? 3 books, 2 tables, 1 books.” The proof response to this audio proof challenge 312 may be four.

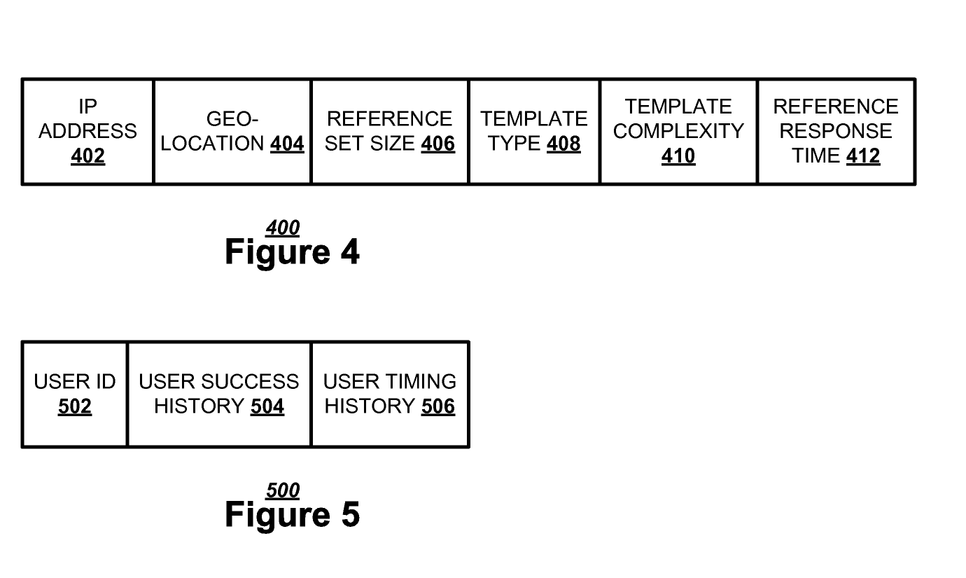

The geo-location database 160 may store a location record to indicate optimum use parameters at each geo-location. FIG. 4 illustrates, in a block diagram, one embodiment of a location record 400. A geo-location traffic database 160 may store location record 400 associating an internet protocol address 402 with a geo-location 404. The location record 400 may identify a reference proof challenge set size 406 based on the reputation for access requests from that geo-location 404. For example, a geo-location with a reputation for hosting malicious actors may have a larger proof challenge set size 406. The location record 400 may identify a number of different template types 408 that may be used at that geo-location 404. Further, the location record 400 may associate a template complexity score 410 for that template type 408. The location record 400 may identify an initial reference response time 412 based on the network speed associated with that geo-location 404 and the template complexity score 410 of that template type 408.

The human interactive proof portal 140 may maintain a user record of the user device 110. FIG. 5 illustrates, in a block diagram, one embodiment of a user record 500. The human interactive proof portal 140 may identify the user record 500 with a user device identifier (ID) 502. The user device identifier 502 may be associated with an internet protocol address of the user or with a cookie stored in the internet browser of the user. The user record 500 may store a user success history 504 tracking the number of audio proof challenges 312 that the user device 110 has solved. The user success history 504 may include partial solves. A partial solve is a response by the user device 110 that provides a close answer to an audio proof challenge, such as identifying 5 books when 4 books are present. The user record 500 may store the user timing history 506 tracking a challenge response time for the human interactive proof session. The user timing history 506 may store an average response time for the audio proof challenges 312 or an array of each response time for each audio proof challenge 312.

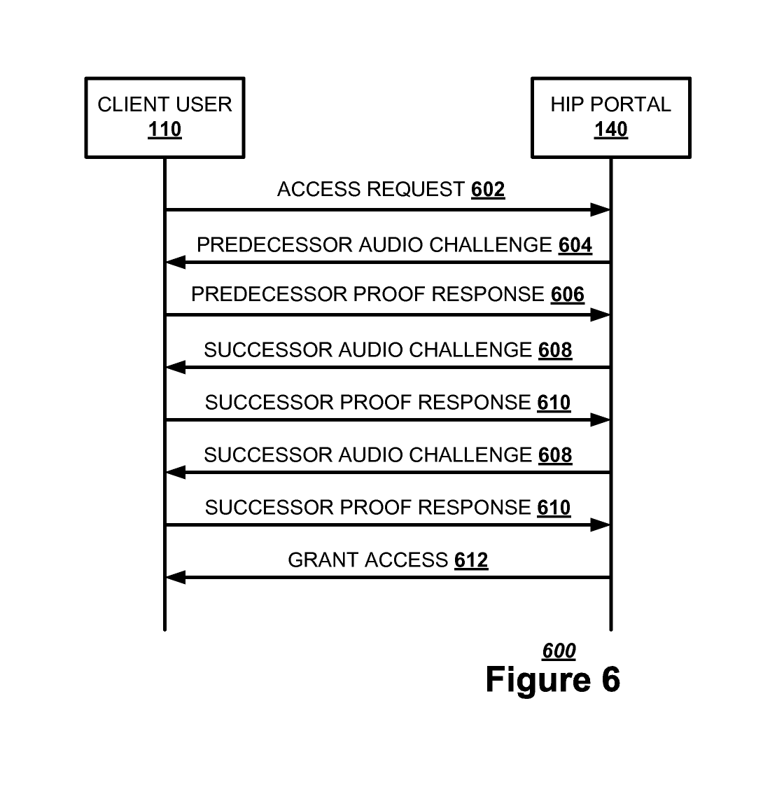

FIG. 6 illustrates, in a flow diagram, one embodiment of a human interactive proof session 600. The user device 110 may send an access request 602 to the human interactive proof portal 140. The human interactive proof portal 140 may return a predecessor audio proof challenge 604 to the user device 110. The user device 110 may provide a predecessor proof response 606 to the human interactive proof portal 140 to solve the predecessor proof challenge 604. The predecessor proof response 606 may be a typewritten response or an audio response recorded by a microphone on the user device and sent as an audio file back to the human interactive proof portal 140. The human interactive proof portal 140 may then return a successor audio proof challenge 608 to the user device 110. The user device 110 may provide a successor proof response 610 to the human interactive proof portal 140 to solve the successor audio proof challenges 608. The successor proof response 610 may be a typewritten response or an audio response recorded by a microphone on the user device and sent as an audio file back to the human interactive proof portal 140. The human interactive proof portal 140 may then return further successor audio proof challenges 608 to the user device 110. The user device 110 may provide further successor proof responses 610 to the human interactive proof portal 140 to solve the successor audio proof challenges 608. If the user device 110 solves a sufficient number of audio proof challenges in the audio proof challenge set, the human interactive proof portal 140 may grant access 612 to the user device 110.

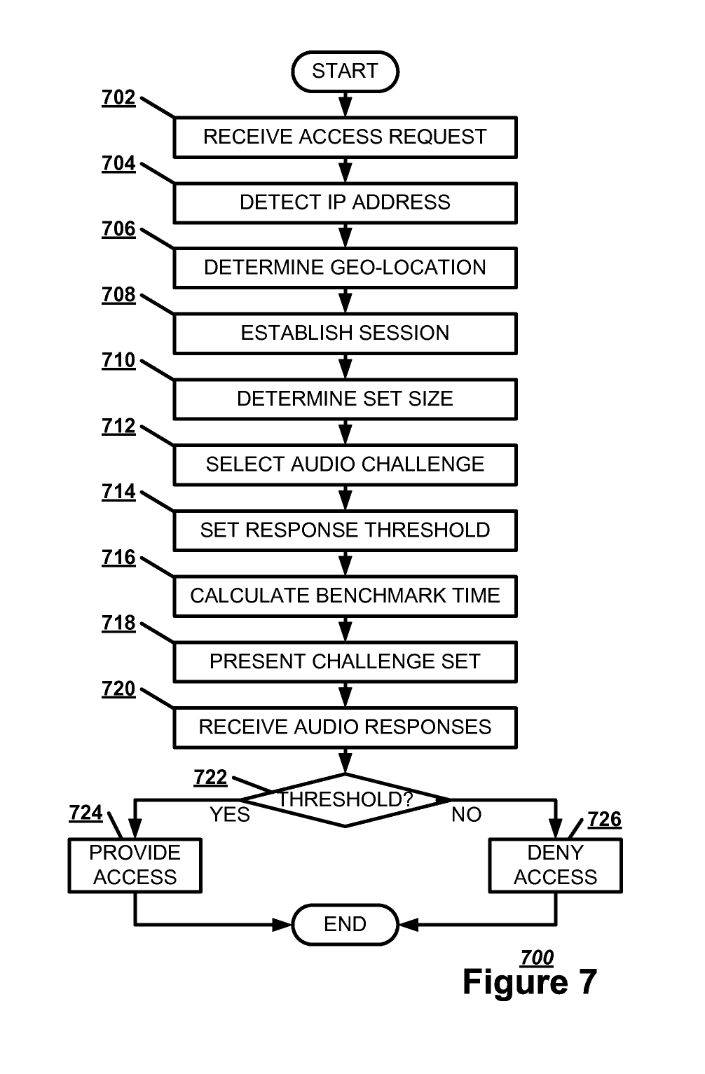

FIG. 7 illustrates, in a flowchart, one embodiment of a method 700 for controlling access to an online data service. A human interactive proof portal 140 may receive an access request 602 for an online data service 122 from a user device 110 (Block 702). The human interactive proof portal 140 may detect the internet protocol address for the user device 110 (Block 704). The human interactive proof portal 140 may determine a user geo-location based on the internet protocol address of the user device 110 (Block 706). For example, the human interactive proof portal may check the internet protocol address 402 against a geo-location database 160. The human interactive proof portal 140 may establish a human interactive proof session 600 with the user device 110 accessing an online data service 122 (Block 708). The human interactive proof portal 140 may determine a challenge set size for the audio proof challenge set based on a user demographic, such as geo-location (Block 710). The human interactive proof portal 140 may select an audio proof challenge set of one or more audio proof challenges from an audio proof challenge database 150 (Block 712). Alternately, the human interactive proof portal 140 may automatically generate the audio proof challenge set at runtime. The human interactive proof portal 140 may set a response threshold for the human interactive proof session based on a user demographic, such as geo-location (Block 714). A response threshold is the number of proof responses that solve the audio proof challenges before the human interactive proof portal 140 may grant access to the online data service 122. The response threshold may be a percentage of the challenge set size. The human interactive proof portal 140 may calculate a benchmark response time based on a user location (Block 716). The human interactive proof portal 140 may iteratively send an audio proof challenge set having multiple audio proof challenges each asking a semantic query to the user device for presentation to a user (Block 718). The human interactive proof portal 140 may receive a proof response, such as an audio proof response, to each audio proof challenge in the audio proof challenge set presented to the user device 110 (Block 720). If the user achieves the response threshold (Block 722), the human interactive proof portal 140 may provide access to the online data service 122 based in part on the human interactive proof session and at least one proof response having a semantic reply indicating a human user (Block 724). Otherwise, the human interactive proof portal 140 may deny access to the online data service 122 (Block 726).

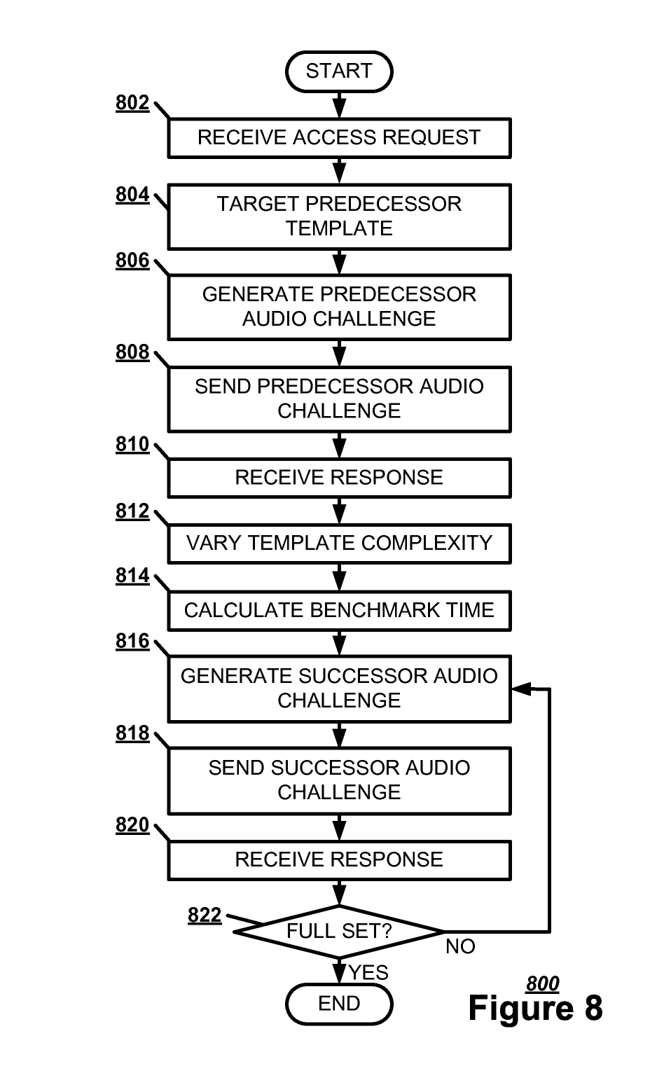

FIG. 8 illustrates, in a flowchart, one embodiment of a method 800 for executing an iterative human interactive proof session 600. The human interactive proof portal 140 may receive an access request for an online data service 122 from a user device 110 (Block 802). The human interactive proof portal 140 may target a predecessor semantic query template 322 to a limited response pool (Block 804). The human interactive proof portal 140 may generate the predecessor audio proof challenge automatically from a predecessor semantic query template 322 (Block 806). The human interactive proof portal 140 may send a predecessor audio proof challenge 604 asking a predecessor semantic query to the user device 110 for presentation to a user (Block 808). A predecessor proof challenge 604 is a proof challenge that precedes a successor proof challenge. The human interactive proof portal 140 may receive from the user device 110 a predecessor proof response 606 having a predecessor semantic reply indicating a human user (Block 810).

The human interactive proof portal 140 may vary a template complexity between a predecessor semantic query template 322 and a successor semantic query template 322 (Block 812). The human interactive proof portal 140 may calculate a benchmark response time based on a template complexity (Block 814). The human interactive proof portal 140 may generate the successor audio proof challenge automatically from a successor semantic query template 322 (Block 816). The human interactive proof portal 140 may send a successor audio proof challenge 604 asking a successor semantic query to the user device 110 for presentation to the user (Block 818). A successor proof challenge 604 is a proof challenge that follows a predecessor proof challenge. The human interactive proof portal 140 may receive from the user device 110 a successor proof response 606 having a successor semantic reply indicating a human user (Block 820). If the human interactive proof portal has not sent the complete set of audio proof challenges (Block 822), the human interactive proof portal 140 may generate the next successor audio proof challenge (Block 816).

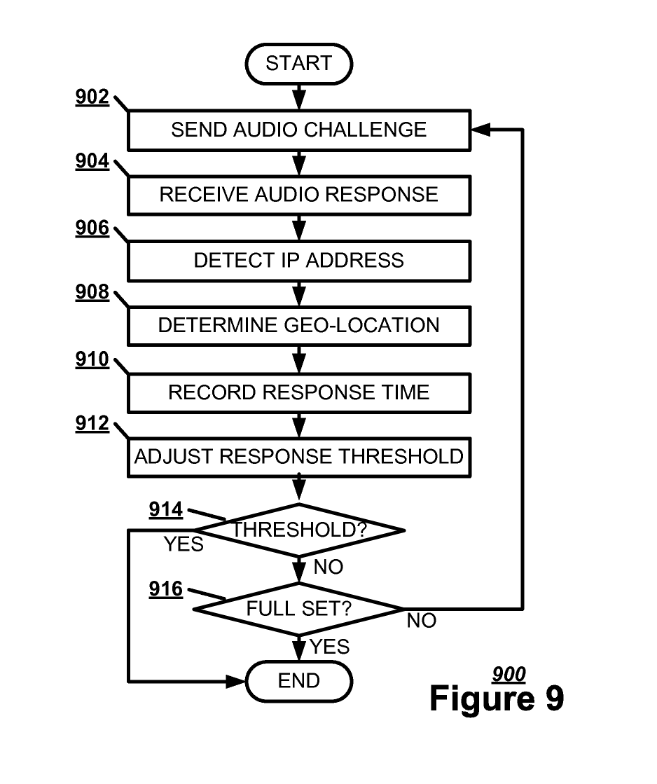

The human interactive proof portal 140 may base the number of audio proof challenges sent in a human interactive proof session on a user's performance during the human interactive proof session. FIG. 9 illustrates, in a flowchart, one embodiment of a method 900 for adjusting a response threshold based on user performance. A human interactive proof portal 140 may send an audio proof challenge asking a semantic query to the user device 110 for presentation to a user (Block 902). The human interactive proof portal 140 may receive a proof response from the user device 110 as an audio proof response (Block 904). The human interactive proof portal 140 may detect the internet protocol address sending the proof response (Block 906). The human interactive proof portal 140 may determine the geo-location based on the internet protocol address (Block 908). The human interactive proof portal 140 may record a user response time for the proof response (Block 910). The human interactive proof portal 140 may adjust a response threshold for the human interactive proof session based on a user response score, a user response time, the user geo-location, the internet protocol address reputation, or other factors (Block 912). If the response threshold has not been reached (Block 914) and the full audio proof challenge set has not been used (Block 916), the human interactive proof portal 140 may send the next audio proof challenge asking a semantic query to the user device 110 for presentation to the user (Block 902).

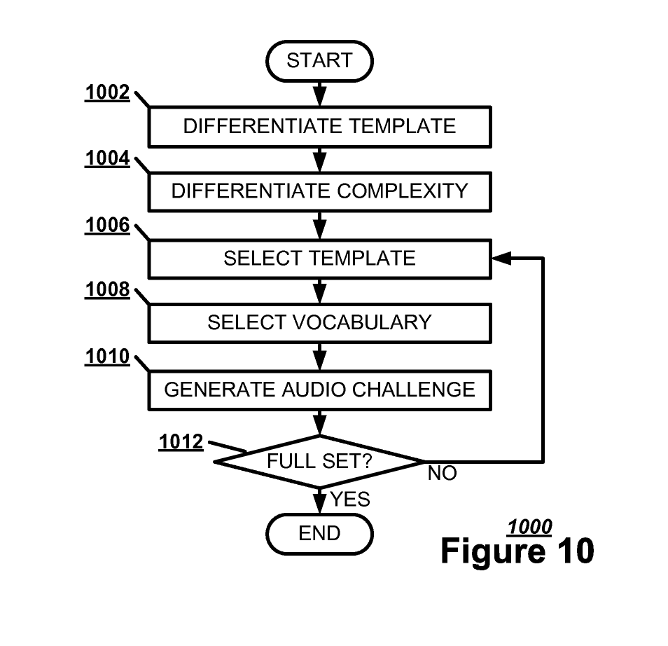

FIG. 10 illustrates, in a flowchart, one embodiment of a method 1000 for generating an audio proof challenge set. The human interactive proof portal 140 may differentiate a semantic query template for each audio proof challenge in the audio proof challenge set (Block 1002). The human interactive proof portal 140 may differentiate the template complexity between the semantic query templates 322 (Block 1004). The human interactive proof portal 140 may select a semantic query template 322 from an audio proof challenge database 150 (Block 1006). The human interactive proof portal 140 may select one or more vocabulary set 332 from an audio proof challenge database 150 (Block 1008). The human interactive proof portal 140 may generate an audio proof challenge of an audio proof challenge set automatically from a semantic query template 322 and the vocabulary set 332 (Block 1010). If a full audio proof challenge set has not been generated (Block 1012), the human interactive proof portal 140 may select the next semantic query template 322 from an audio proof challenge database 150 (Block 1006).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to carry or store desired program code means in the form of computer-executable instructions or data structures. Combinations of the above should also be included within the scope of the computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A machine-implemented method, comprising:
establishing a human interactive proof session with a user device accessing an online data service;
sending iteratively an audio proof challenge set having multiple audio proof challenges each asking a semantic query to the user device for presentation to a user; and
providing access to the online data service based in part on at least one proof response having a semantic reply indicating a human user.

2. The method of claim 1, further comprising:
recording a user response time for the proof response.

3. The method of claim 1, further comprising:
determining a user geo-location based on an internet protocol address of the user device.

4. The method of claim 1, further comprising:
calculating a benchmark response time based on a user location.

5. The method of claim 1, further comprising:
selecting the audio proof challenge set from an audio proof challenge database.

6. The method of claim 1, further comprising:
generating an audio proof challenge of the audio proof challenge set automatically from a semantic query template.

7. The method of claim 1, further comprising:
determining a challenge set size for the audio proof challenge set based on a user demographic.

8. The method of claim 1, further comprising:
setting a response threshold for the human interactive proof session based on a user demographic.

9. The method of claim 1, further comprising:
adjusting a response threshold for the human interactive proof session based on a user response score.

10. The method of claim 1, further comprising:
adjusting a response threshold for the human interactive proof session based on a user response time.

11. The method of claim 1, further comprising:
differentiating a semantic query template for each audio proof challenge in the audio proof challenge set.

12. The method of claim 1, further comprising:
receiving the proof response as an audio proof response.

13. A tangible machine-readable medium having a set of instructions detailing a method stored thereon that when executed by one or more processors cause the one or more processors to perform the method, the method comprising:
receiving an access request for an online data service from a user device;
sending a predecessor audio proof challenge asking a predecessor semantic query to the user device for presentation to a user;
receiving from the user device a predecessor proof response having a predecessor semantic reply indicating a human user;
sending a successor audio proof challenge asking a successor semantic query to the user device for presentation to the user; and
receiving from the user device a successor proof response having a successor semantic reply indicating a human user.

14. The tangible machine-readable medium of claim 13, wherein the method further comprises:
generating the predecessor audio proof challenge automatically from a predecessor semantic query template.

15. The tangible machine-readable medium of claim 13, wherein the method further comprises:
generating the successor audio proof challenge automatically from a successor semantic query template.

16. The tangible machine-readable medium of claim 13, wherein the method further comprises:
varying a template complexity between a predecessor semantic query template and a successor semantic query template.

17. The tangible machine-readable medium of claim 13, wherein the method further comprises:
targeting a predecessor semantic query template to a limited response pool.

18. The tangible machine-readable medium of claim 13, wherein the method further comprises:
calculating a benchmark response time based on a template complexity.

19. A human interactive proof portal, comprising:
a communication interface that establishes a human interactive proof session with a user device using an audio proof challenge set having multiple audio proof challenges each asking a semantic query; and
a processor that provides access to an online data service based on the human interactive proof session.

20. The human interactive proof portal of claim 19, further comprising:
a clock that records a challenge response time for each audio proof challenge.
